(19) United States
(12) Patent Application Publication
(10) Pub. No.: US 2026/0219660 A1
(43) Pub. Date: Jul. 30, 2026

(54) METHOD OF PLANNING A CONVEYOR ARRANGEMENT

(71) Applicant: INTERROLL HOLDING AG, Sant'Antonino (CH)

(72) Inventor: Christian Ripperda, Hückelhoven (DE)

(21) Appl. No.: 19/146,896

(22) PCT Filed: Jan. 12, 2024
(86) PCT No.: PCT/EP2024/050660

§ 371 Date: Jul. 9, 2025

(30) Foreign Application Priority Data
Jan. 12, 2023 (EP) 23151253.4
Mar. 2, 2023 (EP) 23159563.8

(51) Int. Cl. G05B 19/418; B65G 43/10

(52) U.S. Cl. CPC G05B 19/4189; B65G 43/10; G05B 2219/13; G05B 2219/2621

(57) ABSTRACT

A method of planning a conveyor arrangement adapted to convey an object from at least one feed in station selectively to a selected destination from a plurality of destinations, the method comprising: providing an IT planning tool; arranging representations of a plurality of conveyor zones in a manner, so that an inlet of an downstream conveyor zone is linked to an outlet of an upstream conveyor zone using the IT planning tool; defining a plurality of destinations within the IT planning tool; performing an automated analysis of the arranged representations; based on the performed automated analysis, automatically generating a destination look up table indicating a list of destinations, which are located downstream of each of the outlets of the respective junction zones.

### CROSS REFERENCE TO RELATED APPLICATIONS

This is a US national phase application under 35 U.S.C. § 371 of international patent application no. PCT/EP2024/050660, filed Jan. 12, 2024, which claims priority to European patent application nos. EP 23151253.4 filed Jan. 12, 2023 and EP 23159563.8, filed Mar. 2, 2023.

### TECHNICAL FIELD

The invention refers to a method of planning a conveyor arrangement, in particular an intralogistic conveyor arrangement.

### BACKGROUND OF THE INVENTION

European patent application 22 180 381.0, which is published after the application date of the present application discloses a method for controlling a conveying arrangement. The conveying arrangement has a plurality of conveying sections. A particular aspect of the disclosed controlling method is a lookup table (see FIG. 4 of EP22180381.0), which represents the neighborhood relations between adjacent conveying sections. This application lacks a concept, how these lookup tables are created.

EP 3 222 564 B1 discloses a conveyor for conveying an object from a start position to a target place. The conveyor comprises a plurality of zones into which the conveyor is divided, the object being conveyed across the zones; each of the zones comprising: a linear conveying zone that linearly conveys the object; a conveying direction changing zone selecting a conveying direction of the object to send out the object in the selected conveying direction; a conveyance destination storage unit that is configured to store the conveyance destination information temporarily; an information receiving unit that is configured to receive the conveyance destination information from an upstream zone; and an information transmitting unit that is configured to transmit the conveyance destination information to a downstream zone. The conveyor transfers the conveyance destination information from the upstream zone to the downstream zone with the movement of the object across the zones.

DE 10 2019 135 620 A1 discloses a method for setting up a control system of a conveyor system. The conveyor system comprises a plurality of conveyor segments. Each conveyor segment comprises a conveyor drive for conveying goods through the respective conveyor segment. The controller controls the conveyor drives of the plurality of conveyor segments by the following steps. a) Placing a configuration object on one of the conveyor segments, the configuration object preferably having a marking; b) driving a conveyor drive, whereby the configuration object is conveyed through the conveyor segment to a conveyor segment adjacent thereto; c) detecting a movement of the configuration object occurring as a result of the conveying of the configuration object by means of a camera, in the field of view of which the configuration object is conveyed) creating a zone in the field of view of the image capture device, the zone being spanned by the path travelled by the configuration object through the conveyor segment as seen from the image capture device; e) associating the conveyor drive driven during the movement of the configuration object with the zone in the field of view of the image capture device. f) storing this assignment in a database.

WO 2021/048042 A1 discloses a virtual layouter tool. Here a conveying arrangement can be created in the virtual world using 3D data of individual conveying modules. The 3D data of the conveying devices are arranged in a spatial relation to each other which conforms to a possible relation of the relating real module devices in the real world. The created conveying arrangement in the virtual world can be used in a simulation mode for predicting an efficient use and configuring a sufficient capacity of the conveying arrangement.

US 2005/0065642 A1 discloses a fully installed and operational airport luggage transport system, for transporting items to a destination on predefined transport routes: The system has a plurality of branching locations and comprising: a master controller setting for each transported item the destination and a transport route associated with the destination; a slave controller receiving from the master controller for each destination a forwarding direction at the branching locations. The slave controller identifies an identification number associated with each transported item and transmits the identification number to the master controller, which provides to the slave controller the destination associated with the identification number. The slave controller forwards the item without an interrogation of the master controller, based on the forwarding directions stored at the slave controller. In US 2005/0065642 A1 the feature “a master controller setting for each transported item the destination and a transport route associated with the destination” is of increased importance. At first, the terms “route” and “destination” have different meanings and are not synonyms. In addition, both the route and the destination are set individually for each transported item by the master controller; both the route and the destination are then received by the individual slave controller, which is the controller actually setting the conveying path in the conveying hardware. Accordingly, the switch tables are set during operation of the transport system, not during planning of the transport system. No details of planning such a transport system is disclosed.

US 2018/0162652 A1 discloses a control system for a conveyor system, comprising: a data store that maintains configuration data that describes a configuration of the conveyor system; and a design component configured to enable a user to design a layout and the configuration for the conveyor system, wherein the configuration data includes one or more devices and relationships between the one or more devices. US 2018/0162652 A1 describes in this regard the use of a relational database ([0019]), without providing any details of the content of said a relational database.

### SUMMARY OF THE INVENTION

It is an object of the invention to provide an improved method of setting up a conveyor arrangement in particular to configure the controls.

The invention is in particular intended for planning a conveyor arrangement which is adapted to convey an object from at least one feed in station selectively to a selected destination from a plurality of destinations. The conveyor arrangement comprises; a plurality of conveyor zones, each conveyor zone is adapted to convey an object from an inlet of said conveyor zone to an outlet of said conveyor zone; a plurality of controllers, adapted to control the operation of the conveyor zones; wherein said conveyor zones are arranged in a manner, that said object can be transferred from an outlet of a previous conveyor zone to an inlet of a subsequent conveyor zone. At least one of said conveyor zones is a junction zone having at least two outlets. A junction controller is adapted to control the junction zone in a manner so as to selectively convey said object through a selected outlet of the plurality of outlets of said junction zone.

The method for planning comprising the following steps: using an IT planning tool (also herein referred to as the “Layouter”) by a user; by using the IT planning tool, arranging representations of a plurality of conveyor zones in a manner, so that an inlet of a downstream conveyor zone is linked to an outlet of an upstream conveyor zone; within the planning tool defining a plurality of destinations; performing an automated analysis of the arranged representations; based on the performed analysis, automatically generating a destination look up table, indicating a list of zones and/or destinations, which are located downstream of each of the outlets of the respective junction zone.

In an embodiment the destination look up table comprises a list of destinations each linked to one of the outlets and indicating that an object conveyed through said linked outlet can be conveyed to the linked destination. In particular with the destination look up table a data base in given which support local navigation at each of the junction zones. So by means of the destination look up table at each junction the direction at this particular junction to a desired destination can be queried. In an embodiment there are provided a plurality of destination look up tables, wherein each of said destination look up tables is linked to another junction zone. In an embodiment the destination look up table is established at a very early stage, in particular prior to operation and/or installation of the conveyor arrangement. As a consequence, the destination look up table is independent from the operation of the conveyor arrangement and stays constant during operation. In particular the same destination look up tables are valid for any object conveyed at the related junction. That is a significant difference to the operation of the US 2005/0065642 A1 where the switch tables are adapted for specific items. The initial launch of the conveyor arrangement is made easy, by providing the destination look up tables based on the planning data, since individual programming of routes in the PLC is omitted.

In particular the invention is applicable to a conveyor arrangement (also the the planning of such a conveyor arrangement) where at least two junction zones are located in the path between the feed in station and a destination and the destination look up table is generated for both of the junction zones. Here the destination look up table related to the upstream junction zone indicates the path to the downstream junction zone which is on the path to the destination mentioned in the destination look up table related to the first junction.

Conventionally, a layouter is often used to plan a conveyor arrangement. Conventionally the aim of such a layouter is merely to generate a list of material and to establish an overall space demand of the planned arrangement. According to the invention, the layouter is used for generating a table which is afterwards used by the junction controllers to control operation of the junction zone. Thereby the final topography of the arrangement, which is provided within the layouter, is used to generate the destination look up table which can, according to European patent application 22 180 381.0 be used for controlling operation of the junction controllers (in European patent application 22 180 381.0 these junction controllers are called “sorting controllers”).

In the method of manufacturing a conveyor arrangement, said method of planning is used. Thereby a plurality of junction controllers are provided, wherein in each of the junction controller an individual destination look up table is stored. In particular the stored destination look up table comprises a list of destinations linked to one of the outlets and indicating that an object conveyed through said linked outlet can be conveyed to the linked destination. The junction controller is adapted to control operation of the related junction zone based on the stored destination look up table.

In an embodiment the method comprises the steps of linking a plurality of local controllers, in particular junction controllers, to the arranged representations of the conveyor zones, in particular junction zones, in particular wherein each of the arranged representations of the conveyor zones is linked to at least one of the local controllers.

In an embodiment, in an analyzing step a zone table is established based on the arranged representations. The zone table comprises neighborhood relations of the conveyors.

A neighborhood relation in particular comprises a dataset having at least: a first identification of a first conveyor zone; a second identification of a second conveyor zone; an information indicating if said second conveyor zone is directly located downstream or upstream of said first conveyor zone.

In an embodiment, in an analyzing step a junction table is established based on the arranged representations. The junction table comprises junction relations of the junction zones. E.g., a junction relation comprises a dataset at least comprising: in particular a junction identification of a junction zone; in particular a first identification of a first conveyor zone located downstream of a first outlet of said junction zone; a second identification of a second conveyor zone located downstream of a second outlet of said junction zone; optionally a third identification of a third conveyor zone located downstream of a third outlet of said junction zone. The junction relation further comprising: an information indicating that the first conveyor zone is located downstream of the first outlet; an information indicating that the second conveyor zone is located downstream of the second outlet; optionally an information indicating that the third conveyor zone is located downstream of the third outlet.

In an embodiment the destination look up table is generated based on information provided in the junction table, optionally added with information contained in the zone table.

In an embodiment the representations comprise a graphical representation of the conveyor zones.

As long as not stated otherwise, each of the steps can be performed by a user input by using the IT planning tool and/or automatically in particular by the IT planning tool; the “and”-option enables hereby e.g. that the IT planning tool provides in a first step a proposal, where the user has the option to amend the proposal by a user input.

The invention is particularly applicable to conveying arrangements which are operated in such a way that a maximum of one conveyed object is conveyed in each conveying zone (in normal operation), and that the conveyed material is conveyed from an upstream conveying zone to a downstream conveying zone.

### BRIEF DESCRIPTION OF THE DRAWINGS

An example embodiment of the invention is described in more detail with the help of the figures; herein show

FIG. 1 a conveyor zone in perspective view;

FIG. 2 a basic conveyor arrangement;

FIG. 3. schematic representations of different conveyor zones;

FIG. 4 principal sketch of a conveying arrangement;

FIG. 5 a personal computer on which the layouter is running in an initial planning step;

FIG. 6 the personal computer of FIG. 5 in a subsequent planning step;

FIG. 7 the personal computer of FIG. 6 in a subsequent planning step;

FIG. 8 the personal computer of FIG. 7 in a subsequent planning step;

FIG. 9 the construction area within the layouter in a subsequent planning step;

FIG. 10 the construction area within the layouter in a subsequent planning step;

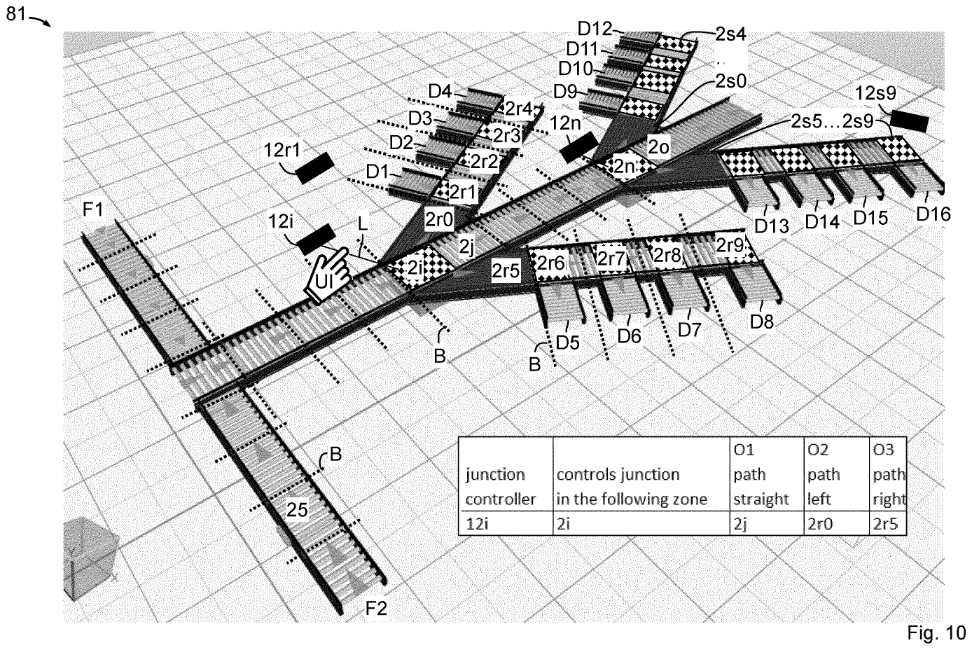

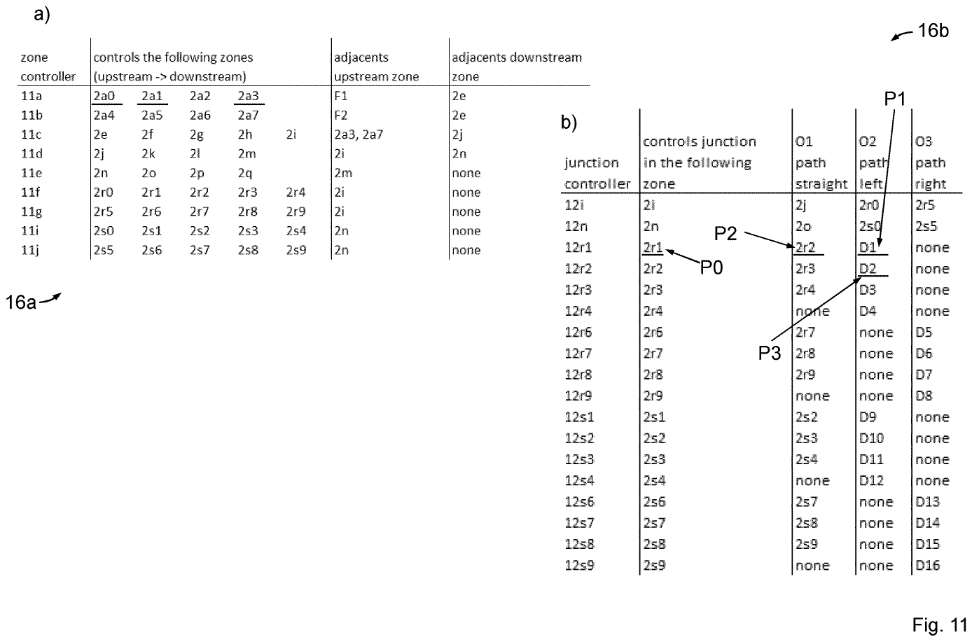

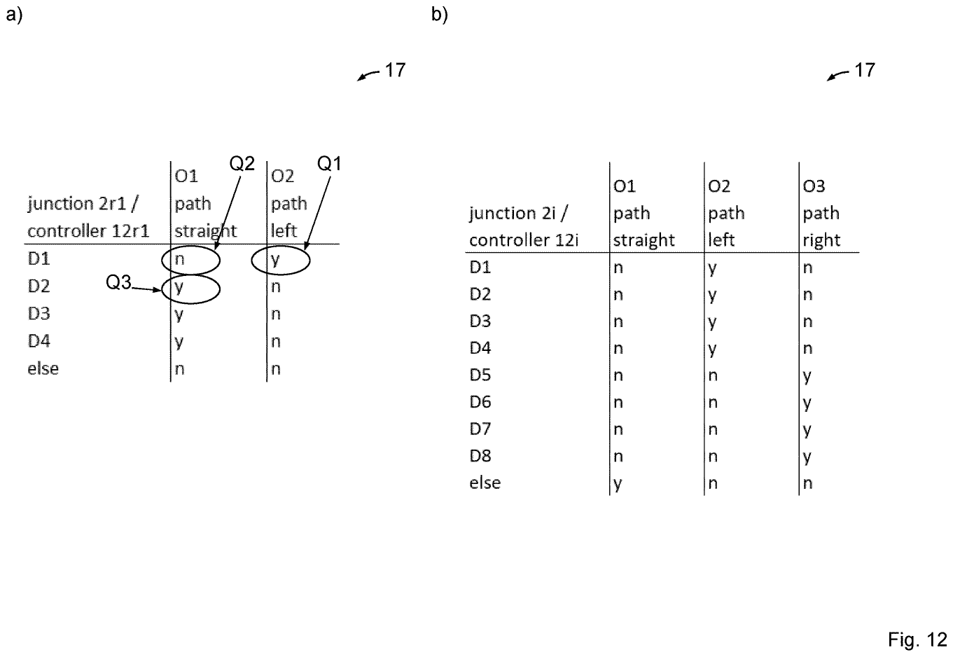

FIG. 11 destination look up tables indicating the destinations between the zones in the planned arrangement of FIG. 10, summarized in
a) a zone table and
b) a junction table;

FIG. 12 relations between the zones in the planned arrangement according to FIG. 10, summarized in
a) a destination look up table for junction 2r1,
b) a destination look up table for junction 2i.

### DETAILED DESCRIPTION

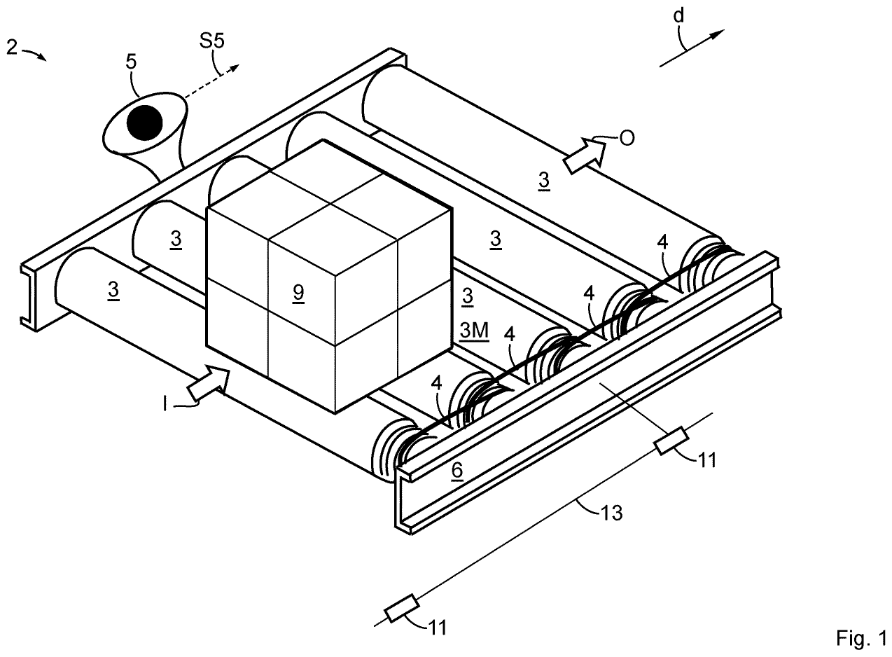

FIG. 1 shows an exemplary conveyor zone 2, comprising several conveyor rollers 3 which are driven together. For this purpose, one of the conveyor rollers 3 is designed as a motor-driven conveyor roller 3M, in particular motorized roller 3M. The motor-driven conveyor roller 3M is driven in particular by a three-phase motor arranged in the conveyor roller 3M. Via one or more drive connectors 4, e.g. a drive belt, the conveyor rollers 3 of a conveyor zone 2 are drive-connected to each other and are jointly driven by the motor-driven conveyor roller 3M. An object 9 is linearly conveyed from an inlet I to an outlet O along a conveying direction d.

By means of a presence sensor 5, the presence of a conveyed object 9 arranged on the conveyor zone 2 can be determined. The presence sensor 5 does not necessarily cover the entire conveyor zone 2; it is sufficient if the presence of a conveyed object 9 within a partial area of the conveyor zone 2 is detected by the presence sensor 5. The presence sensor 5 thereby generates a sensor signal S5, which is connected via a signal line (not shown) to a local zone controller 11 presented further below. Presence detection can also be performed without an explicit sensor and can be derived from other raw data. For example, there are already approaches to derive the presence of a conveyed material on the conveyor zone 2 from other data, e.g. from the course of the current intensity in a conveyor zone 2.

The conveyor rollers 3 and the presence sensor 5 are attached to a common support frame 6. The conveyor rollers 3 of several conveyor zones 2 can be attached to a common support frame 6.

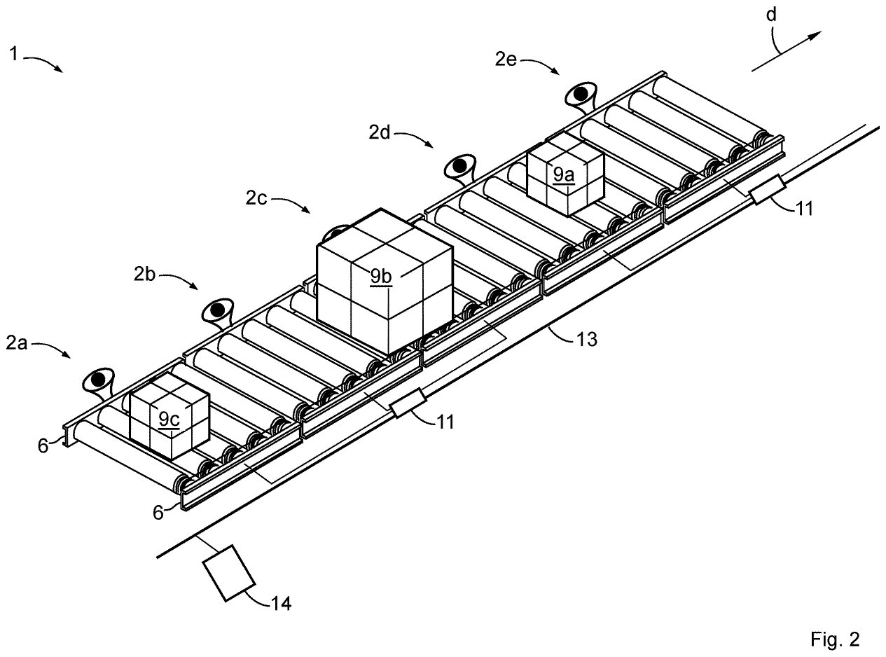

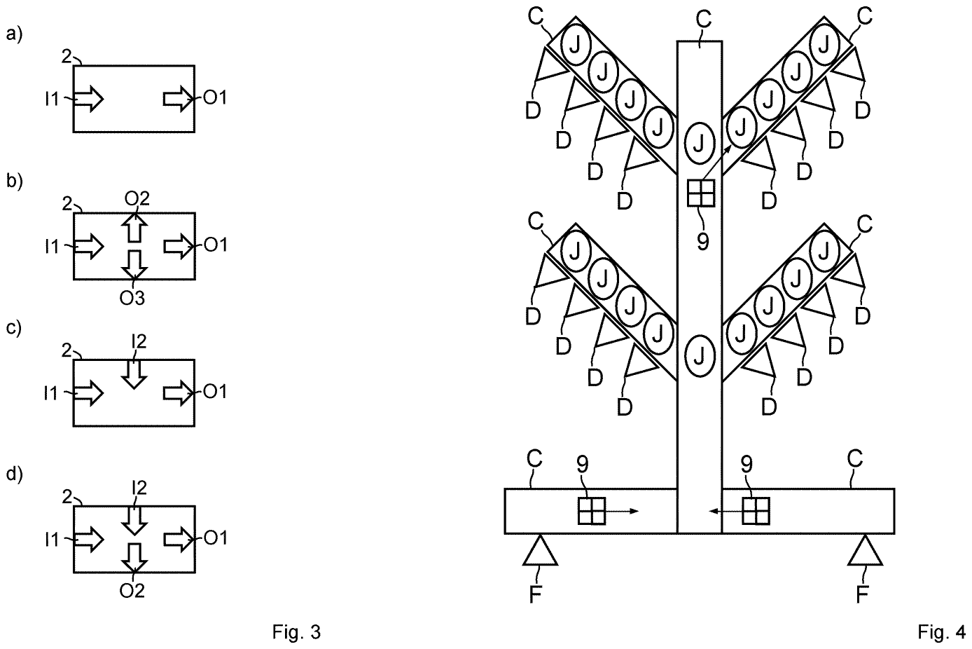

The motor-driven conveyor rollers 3M are each controlled by at least one or a plurality of local zone controllers 11. A single zone controller 11 can control the motor-driven conveyor rollers 3M of several conveyor zones 2. A plurality of zone controllers 11 are arranged in a conveyor arrangement 1 (FIG. 2), which communicate with each other via a bus connection 13.

FIG. 2 shows a basic conveyor arrangement 1, where conveyor zones 2 as described previously are used. A plurality of zone controllers 11 control the operation of the conveyor zones 2. A PLC 14 (programmable logic control) may be provided to control the overall operation of the conveyor arrangement 1.

Scanners (not shown) may be arranged along the zones and provide identification data relating to objects 9a . . . c passing the scanner in the zones. These identification data are sent via bus connection 13 to the PLC 14. The PLC 14 has access to an object data base (not shown), which provides destination data based in the identification of the objects 9. Based on the acquired data the PLC 14 provides operation instruction to a local zone controller 11, how to handle the object 9, i.e. to which of the outlets O said object 9 is to be conveyed.

In an alternative embodiment as described in European patent application 22 180 381.0, no PLC or similar is required. Instead of a PLC the zone controllers are connected to a common higher-level object data broker, in particular via the bus connection, with which the zone controllers are also connected to one another. The data broker provides destination data related to the identified objects and the zone controllers are adapted to control operation of the zones based on the provided destination data. For the purpose of the present invention the provision of a PLC is not required.

In particular the zone controllers 11 control the motor-driven conveyor rollers 3M in such a way that the successively approaching conveyed objects 9 do not collide with each other, which is usually called “zero pressure accumulation”. The control takes place in such a way that essentially only one conveyed object 9 is present per conveyor zone 2. However, slight overlaps may occur. For example, an upstream conveyed object 9b located on an upstream conveyor zone 2c may already enter a downstream conveyor zone 2d even though the downstream conveyed object 9a has not yet left this downstream conveyor zone 2d completely. Among other things, the sensor signals S5 of the presence sensors 5 serve as input variables here, although it is ensured that the two conveyed objects 9 do not touch and thus do not damage each other.

In the following course of the invention, reference is made to conveyor zones, using a schematic representation of said conveyor zone as shown in FIG. 3. Here FIG. 3a represents schematically a conveyor zone 2 of FIG. 1, which has one first inlet I1 and one first outlet O1. No more inlets and outlets are provided. The conveyor zone 2 can also be curved or from other shape.

FIG. 3b shows the representation of another conveyor zone 2 having an extended scope of operation. Here in addition to the conveyor zone 2 of FIG. 3a the conveyor zone 2 has an additional, second outlet O2. The object 9 can be conveyed selectively from said first inlet I1 to one of said first and second outlets O1, O2. Optionally, the conveyor zone 2 has an additional, third outlet O3. In this option, the object 9 can be conveyed selectively from said first inlet I1 to one of said first, second and third outlets O1, O2, O3.

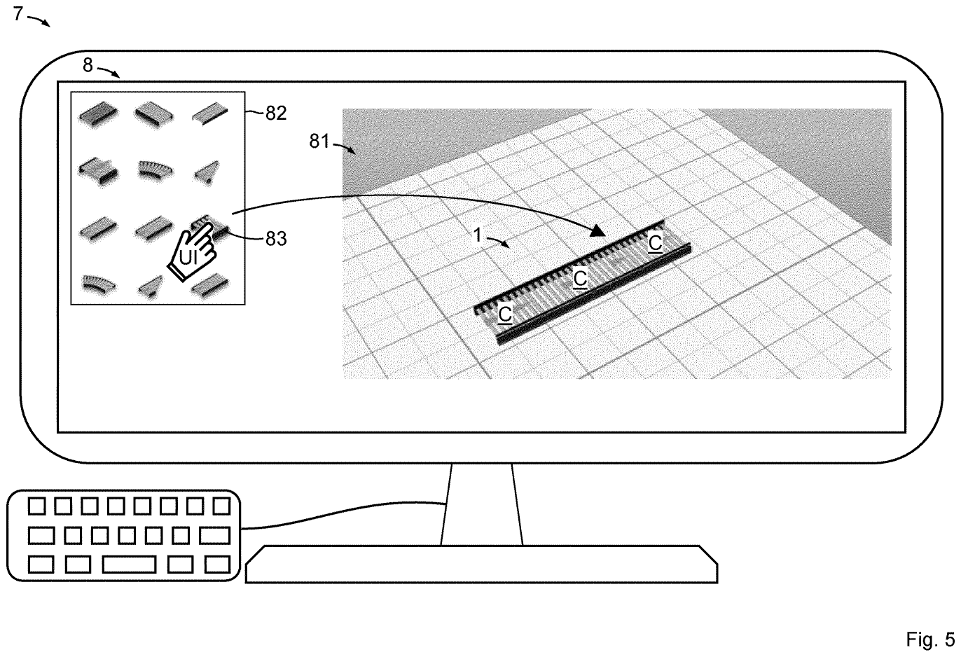

As an example, said conveyor zone 2 of FIG. 3b can be formed by a conveyor zone 2 as shown in FIG. 1, which additionally is provided with a transfer device of as described with reference to FIG. 5 of EP 3 222 564 B1 (in this document and figure the transfer device has reference sign 20).

FIG. 3c shows the representation of a conveyor zone 2 having an extended scope of operation. Here in addition to the conveyor zone 2 of FIG. 3a, the conveyor zone 2 has an additional second inlet I2. Objects 9 can be conveyed from one of said first and second inlets I1, I2 to said first outlet O1.

The transfer device as described with reference to FIG. 3b may also be suitable to provide said additional second inlet I2.

FIG. 3d shows the representation of a conveyor zone 2 having an extended scope of operation. Here in addition to the conveyor zone 2 of FIG. 1 the conveyor zone has an additional second inlet I2 and an additional second outlet O2 and is an example as a combination of the embodiments of FIGS. 3b and 3c.

All conveyor zones 2 are controlled by a zone controller 11 as shown in FIG. 1 or 2, in particular wherein one zone controller 11 may be adapted to control the operation of more than one zone 2.

Starting from FIG. 4 the planning of a conveying arrangement 1, which is performed by a person, herein called the planner.

FIG. 4 shows a principal sketch of what an exemplary conveying arrangement 1 should finally look like.

The exemplary conveyor arrangement 1 according to the sketch has two feed in stations F, where a user can input objects 9 to be conveyed. From the feed in stations F the objects 9 are conveyed to several destinations D by several conveyors C. A plurality of junctions J are provided, at which the objects 9 are selectively transferred onto one of a plurality of routes along the conveyors C. Such a sketch may be only available in the head of a planner.

Reference is now made to FIG. 5. For detailed planning the planner uses an IT tool 8, which is an application program running on a personal computer 7, where the term personal computer also includes tablet PC or similar devices. The IT tool 8 is herein also called the “layouter”.

The layouter 8 provides a construction area 81 in which the planner can create a digital representation of a conveying arrangement 1. The layouter 8 provides a selection area 82, in which components are provided for being selected by the planner. By a user interaction UI the user can select a graphical representation 83 of a certain component and transfers the selected component via drag & drop into the construction area 81.

After a few repetitions a small conveying arrangement 1 has been created already in the construction area 81, comprising a straight line of roller conveyors C.

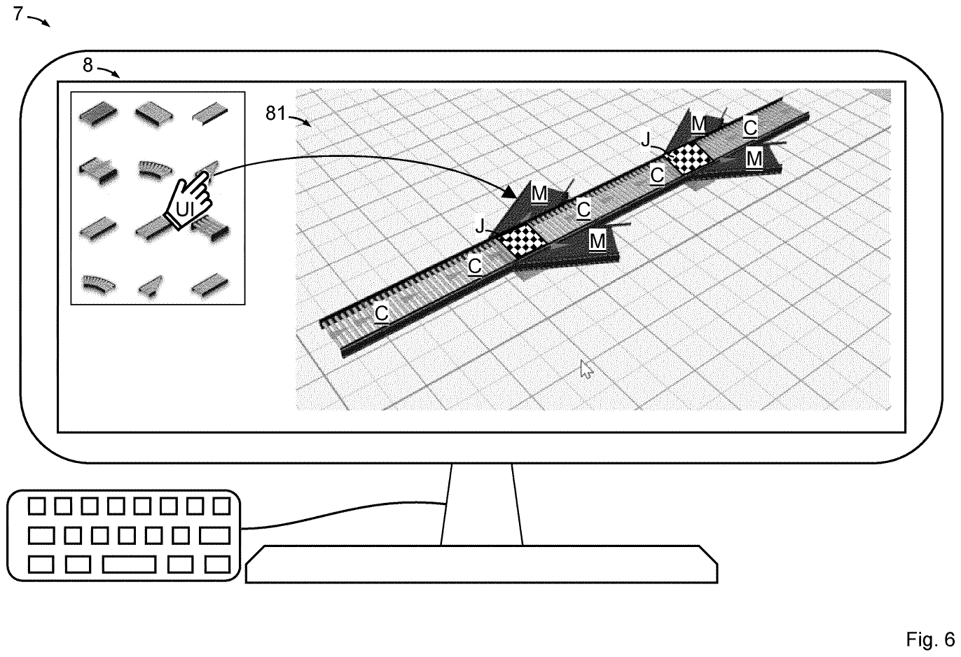

FIG. 6 shows in the construction area 81 the representation of the further developed conveyor arrangement 1. In addition to the situation in FIG. 5, the conveyor arrangement 1 comprises now the junctions J as well as a number of merges M branching off at the junctions J.

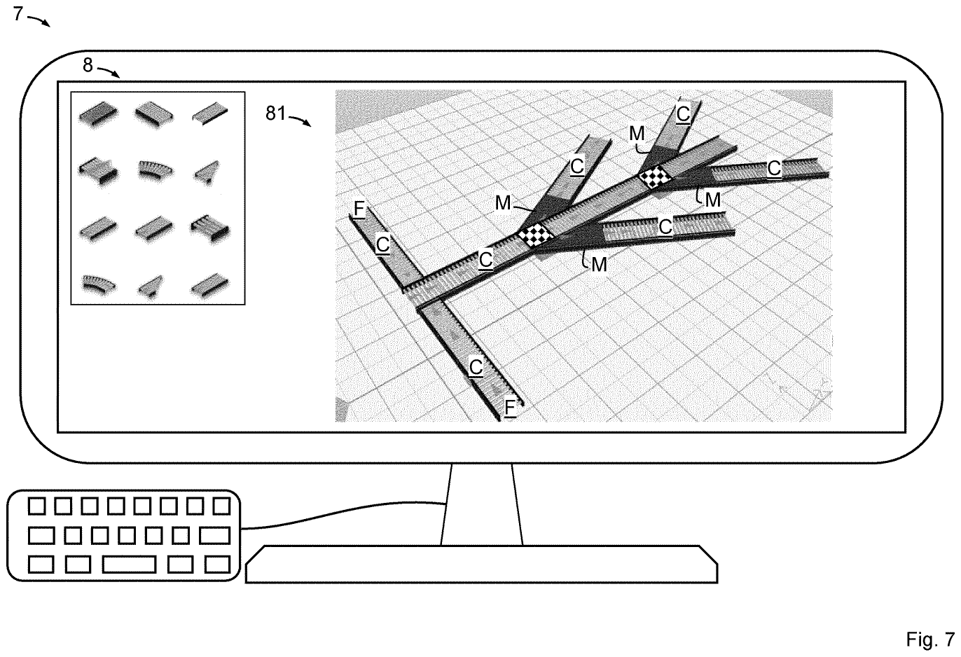

FIG. 7 shows in the construction area 81 the representation of the further developed conveyor arrangement 1. In addition to the situation in FIG. 6, the conveyor arrangement 1 comprises now additional conveyors C downstream of the merges M. Also the feed in stations F and the connecting conveyors C are provided, which are connected in particular via a junction to the previous conveyors C.

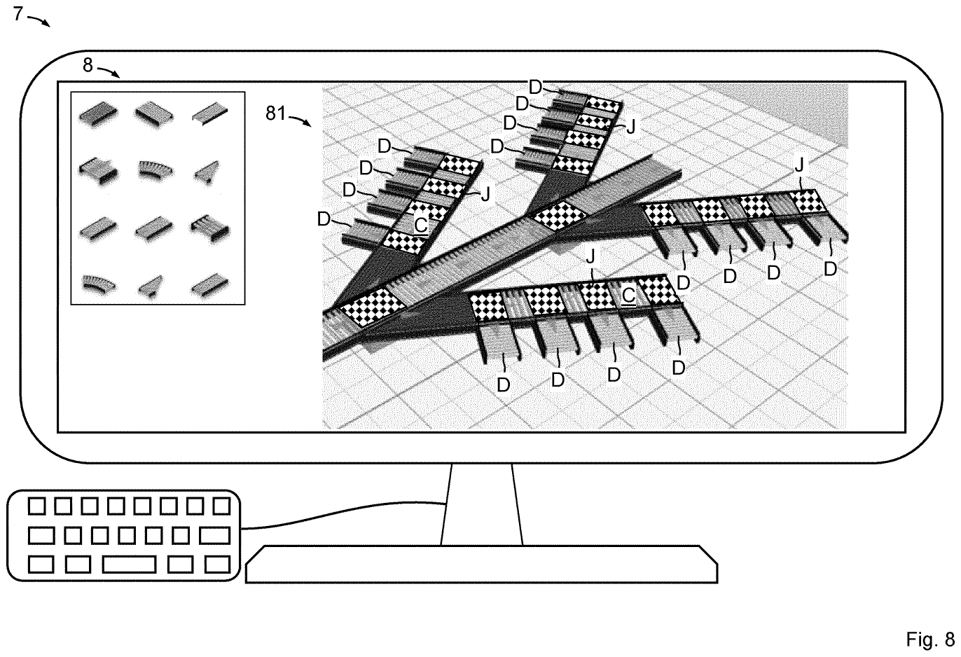

FIG. 8 shows in the construction area 81 the representation of the further developed conveyor arrangement 1. In addition to the situation in FIG. 7, the conveyor arrangement 1 comprises the destinations D branching off from the conveyors C downstream of the merges M. Additional junctions J are provided where the destinations D branching off from conveyors C.

As can be realized by a comparison between the FIGS. 8 and 7 the focus and the view direction of the construction area can be varied by the planner.

The junction J can be realized by various embodiments. As a usual embodiment a junction J can be established by a roller conveyor which is equipped with a transfer device such as shown e.g. in FIG. 5 of EP 3 222 564 B1.

Now representations of the main components, which during intended usage perform the conveying and sorting operations, are provided in the conveyor arrangement 1 within the construction area 81 according to FIG. 8.

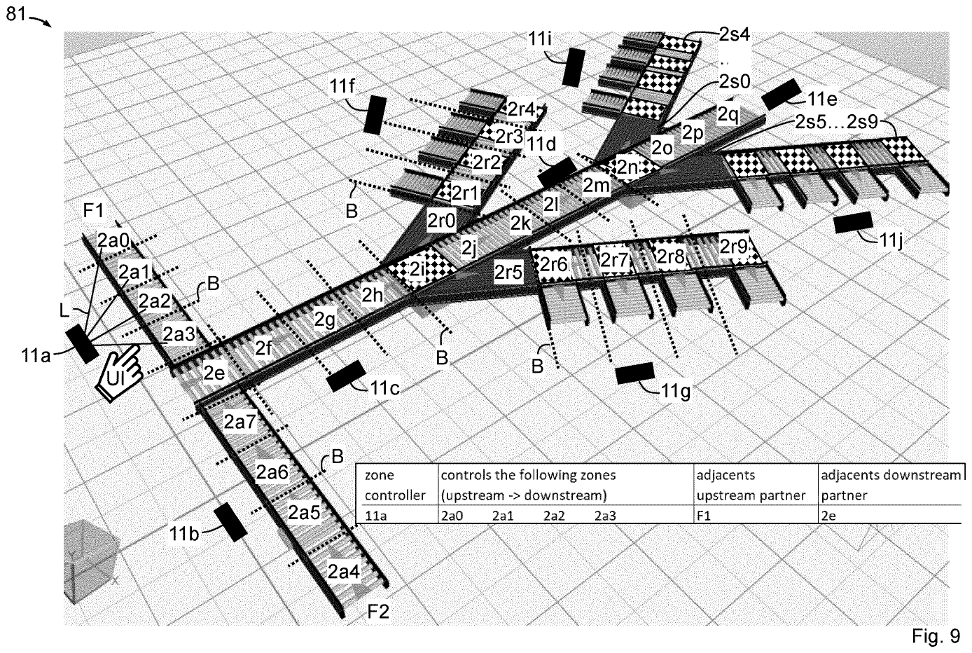

Subsequently, additional tasks are performed with the help of the layouter 8. For a better visibility in FIG. 9 the focus is set to a small area of the representation of the conveyor arrangement 1 and merely the construction area 81 is shown; nevertheless, the following steps are also done for the other areas of the conveyor arrangement 1.

The selection of the Conveyors C as described previously defines already the position of individual conveyor zones 2 and zone borders B defined between the conveyor zones 2. FIG. 9 shows a selection of individual conveyor zones 2a . . . 2s9 and the respective zone borderlines B (where only a few borderlines are depicted), which are also made visible to the planner 9 in the construction area 81 e.g. by the dotted lines. Also the planner has indicated via a user interaction the destinations D1 . . . D16.

The visualization of the zones 2 provide a good starting point for the planning of a control system for controlling the conveyor arrangement 1. From a selection area (not shown in FIG. 9), the planner can select local zone controllers 11, which are then associated to the hardware shown in the construction area 81.

In a planning step each of the zones are associated with at least one zone controller 11a, 11b, 11c, 11d, 112, 11f, 11g, 11h, 11i. As an example more than one zone 2 can be allocated to one zone controller 11. The allocation can be done by a user interaction UI, e.g. by drawing a connecting line L between the zone controller 11a and the conveyor zone 2a3. The previous described step is repeated for all other conveyor zones 2 and zone controllers 11. For better visibility in the FIG. 9, such connecting lines are merely shown for zone controller 11a. The position of the controller shown in the construction area 81 may deviate from the location in the real conveyor arrangement 1. Alternatively the allocation can be done automatically by the IT planning tool.

In the table shown in FIG. 9, the allocation of the zones to one controller is shown. I addition it is shown, which partners, in particular zones, are adjacent to the allocated zones in the upstream and downstream direction. Here in the upstream direction the feed-in station F1 is located upstream of the upstream allocated zone 2a0; the zone 2e is located downstream of the downstream allocated zone 2a3.

The overall result of this allocation for the entire conveyor arrangement 1 can be seen in a zone table 16a, shown in FIG. 11a. In the zone table 16a relevant information for all zone controllers 11a, 11b, 11c, 11d, 112, 11f, 11g, 11h, 11i 11j is provided. In the first column, the individual zone controllers 11a . . . 11j are identified. In the second column, all conveyor zones 2 are defined, which are controlled by the individual zone controller 11 mentioned in the first column of the same line. According to the first line the individual controller 11a controls the conveyor zones 2a0 (1. position in the conveying direction), 2a1 (2. position), 2a2 (3. position) and 2a3 (4. position).

Within the zone table also an information is provided about the sequence of the conveyor zones in the conveying direction d allocated to one common zone controller; as an example the conveyor zones are listed according to their position along the conveying direction, in so that the most upstream conveyor zone is listed in the first position where the most downstream conveyor zone is listed in the last position.

The third column contains an identification of the zone, which is upstream of the most upstream conveyor zone 2a0. In the present case here the feed in position F1 is located upstream. The fourth column contains an identification about the zone, which is downstream of the most downstream conveyor zone 2a3. In the present case here the conveyor zone 2e is located downstream. The information of the same kind is provided in individual zone tables 16a similar to the one shown in FIG. 11a for all other zone controllers and zones. It is self-evident, that the information does not need to be provided in a table exactly as shown here. There are various embodiments possible how this information can be contained. Any suitable database including the relevant information may be sufficient and is to be considered as a zone table within the meaning of the present invention.

Accordingly the zone table shows a plurality of neighborhood relations. As an exemplary neighborhood relation zone 2a0 (first zone) and zone 2a1 (second zone, both controlled by same zone controller 11a), wherein the second zone 2a1 is directly located downstream of the first zone 2a0. As another exemplary neighborhood relation zone 2a3 (first zone) and zone 2e (second zone, both controlled by different zone controllers, here zone controllers 11a and 11c), wherein the second zone 2e is directly located downstream of the first zone 2a3 (see underlined positions in FIG. 11a).

In another planning step each of the junctions J are associated with at least one junction controller 12i, 12n, 12r1, . . . , 12s9, only a small selection of which are shown in FIG. 10. The allocation can be done by a user interaction UI, e.g. by drawing a line L between the junction controller 12i and the conveyor zone junction in zone 2i. The previous described step is repeated for all other junction zones and junction controllers 12. For better visibility in the FIG. 10, such a linking line L is merely shown for junction controller 12i. The position of the controller shown in the construction area 81 may deviate from the location in the real conveyor arrangement 1. Alternatively the allocation can be done automatically by the IT planning tool.

The result of this allocation is summarized in a junction table 16b shown in FIG. 11b. Here relevant information for all junction controllers 12i, 12n, 12r1, . . . , 12s9 is provided. In the first column, the individual junction controllers 12i, 12n, 12r1, . . . , 12s9 are identified. In the second column, the junction zones 2i, 2n, 2r1, . . . 2s9 are defined, which are controlled by the individual junction controller listed in the first column of the same line. According to the first line, the individual junction controller 12i controls the junction in the zone 2i. To make understanding easy, in the present example the reference signs of the individual junction controllers 12 are provided with the same indices as reference signs of the individual allocated zone (also called the junction zones), in which junctions to be controlled by the junction controllers are located.

The third, fourth and fifth column contain junction relations. Hereby an identification of the individual zones is provided, which are located downstream of the junction zone identified in the first column at the respective outlets O1, O2, O3 (see FIG. 3b). The third column thereby defines, that zone 2j is downstream of the first outlet O1 (straight direction) of junction zone 2i. The fourth column thereby defines, that zone 2r0 is downstream of the second outlet O2 (left direction) of junction zone 2i. The fifth column thereby defines, that zone 2r5 is downstream of the third outlet O3 (right direction) of junction zone 2i.

From this information contained in the zone tables 16a and the junction table 16b of FIG. 11 a path information can be calculated from individual zones to all destinations. As an example for zone 2r1/junction controller 12r1 (see position P0 in FIG. 11b):

Position P1 (FIG. 11b) shows, that in zone 2r1 outlet O2 leads directly to destination D1. This information can directly be transferred into a destination look up table 17 shown in FIG. 12a, line 1 (see “y” for yes” at position Q1 in FIG. 12a). Unless indicated otherwise, from this information it is evident, that destination D1 cannot be reached via outlet O1. This information can also be added to destination look up table 17 shown in FIG. 12a (see “n” for “no” at position Q2 in FIG. 12a).

Position P2 in FIG. 11b shows, that outlet O1 of zone 2r1 leads to zone 2r2. This is not a direct indication for a destination, which can be reached via outlet O1. But this serves as a basis for other queries. In particular Position P3 in the junction table of FIG. 11b shows that via said zone 2r2, destination D2 can be reached. So indirectly the destination D2 can be reached via outlet O1 of zone 2r1 and outlet O2 of zone 2r2. As a result an “y” can be inserted into the destination of look up table of FIG. 12 for zone 2r1 for destination D2 via outlet O1 (see position Q3 in FIG. 12a. Also the information about downstream zones in the zone table of FIG. 11a can be used to generate the destination look up table 17.

That above description shows merely an excerpt of an analysis of the data contained in the zone table 16a and the junction table 16b of FIG. 11 and how this information can be used to generate the destination look up table of FIG. 12. The described steps lead to a complete set of look up tables as exemplary shown in FIGS. 12a, 12b. It is apparent that the generation of the look up table in FIG. 12b is more complex than the look up table of FIG. 12a, since more junctions are arranged subsequently in a row. But the method of analyzing is in main the same.

As can be seen in the look up table of FIG. 12b it is not required that explicit information needs to be provided in the destination look up tables for all destinations. An “else” condition can also provide the required information for remaining destinations, which are not explicitly listed.

A destination look up table as described above can be used as the look up table shown in FIG. 4 of EP22180381.0 and can be created for each junction/zone and junction controller. The destination look up table is afterwards transferred into the real junction controller for supporting the sorting operation in the respective junction controller.

### LIST OF REFERENCE SIGNS

1 conveyor arrangement
2 conveyor zone
3 conveyor roller
3M motor-driven conveyor roller
4 drive connector
5 presence sensor
6 support frame
7 PC, personal computer
8 IT tool/Layouter
9 object to be conveyed
11 local zone controller
12 local junction controller
13 bus connection
14 PLC
16a zone table
16b junction table
17 destination look up table
81 construction area
82 selection area
83 graphical representation of a component
B zone borderline
C conveyor
D destination
F feed in station
inlet
J junction
L line
M merge
O outlet
S5 sensor signal (of presence sensor)
UI user interaction
d conveying direction

1. A method of planning a conveyor arrangement (1) adapted to convey an object (9) from at least one feed in station (F1, F2) selectively to a selected destination from a plurality of destinations (D1 . . . D16), the conveyor arrangement (1) comprising:
a plurality of conveyor zones (2), each conveyor zone is adapted to convey an object (9) from an inlet (I) of said conveyor zone (2) to an outlet (O) of said conveyor zone (2); and
a plurality of controllers (11, 12), adapted to control the operation of the conveyor zones (2);
wherein said conveyor zones (2) are arranged in a manner, that said object (9) can be transferred from an outlet (O) of a, in particular direct, upstream conveyor zone (2) to an inlet (1) of a subsequent conveyor zone (2),
wherein at least one of said conveyor zones (2) is a junction zone (2i . . . 2s9) having at least two outlets (O1, O2, O3),
wherein a junction controller (12) is adapted to control the junction zone (2i . . . 2s9) in a manner so as to selectively convey said object (9) through a selected outlet (O) of the plurality of outlets (O1, O2, O3) of said junction zone (2i . . . 2s9);
the method for planning comprising the following steps:
providing an IT planning tool (8);
arranging representations (83) of a plurality of conveyor zones (2) in a manner, so that an inlet (I) of an downstream conveyor zone (2) is linked to an outlet (O) of an upstream conveyor zone (2) using the IT planning tool (8);
defining a plurality of destinations (D1 . . . D16) within the IT planning tool (8);
performing an automated analysis of the arranged representations (83);
based on the performed automated analysis, automatically generating a destination look up table (17), in particular a plurality of individual destination look up tables (17), indicating a list of destinations (D1 . . . D16), which are located downstream of each of the outlets (O) of the respective junction zones (2i . . . 2s9).

2. The method according to claim 1, characterized in that the destination look up table (17) comprises a list of destinations, each linked to one of the outlets and indicating that an object conveyed through said linked outlet can be conveyed to the linked destination.

3. The method according to claim 1, characterized by the step of automatically generating a plurality of individual destination look up tables (17), each individual destination look up table relating to an individual respective junction zone.

4. The method according to claim 1, characterized in that the automatic generation of the destination look up table is performed prior to the operation and/or installation of the conveying arrangement.

5. The method according to claim 1, characterized in that the same destination look up tables are valid for any object (9) conveyed at the related junction.

6. The method according to claim 1, further comprising the steps of linking a plurality of local controllers (11, 12), in particular junction controllers (12), to the arranged representations of the conveyor zones, in particular junction zones (2i . . . 2s9), in particular wherein each of the arranged representations (83) of the conveyor zones (2) is linked to at least one of the local controllers (11, 12).

7. The method according to claim 1, wherein in an analyzing step a zone table (16a) is established based on the arranged representations (83), wherein the zone table (16a) comprises neighborhood relations of the conveyor zones (2), in particular a neighborhood relation comprises a dataset at least comprising:
a first identification of a first conveyor zone,
a second identification of a second conveyor zone, and
an information indicating if said second conveyor zone is directly located downstream or upstream of said first conveyor zone.

8. The method according to claim 1, wherein in an analyzing step a junction table (16b) is established based on the arranged representations (83), wherein the junction table (16b) comprises junction relations of the junction zones (2i . . . 2s9), in particular a junction relation comprises a dataset at least comprising:
in particular a junction identification (2i) of a junction zone,
a first identification (2j) of a first conveyor zone located downstream of a first outlet (O1) of said junction zone (2i),
a second identification (2r0) of a second conveyor zone located downstream of a second outlet (O2) of said junction zone (2i),
optionally a third identification (2r5) of a third conveyor zone located downstream of a third outlet (O3) of said junction zone (2i),
an information indicating that the first conveyor zone (2j) is located downstream of the first outlet (O1),
an information indicating that the second conveyor zone (2r0) is located downstream of the second outlet (O2),
optionally an information indicating that the third conveyor zone (2r5) is located downstream of the third outlet (O3).

9. The method according to claim 8, wherein the destination look up table (17) is generated based on information provided in the junction table (16b).

10. The method according to claim 8, wherein the destination look up table (17) is generated based on information provided in the junction table (16b) and added with information contained in the zone table (16a).

11. The method according to claim 1, wherein the representations (83) comprise a graphical representation of the conveyor zones (2).

12. A method of manufacturing a conveyor arrangement (1) comprising the method of planning according to claim 1.

13. A method of manufacturing a conveyor arrangement (1) according to claim 12, characterized by the step prior to operation of the conveyor arrangement: transferring a generated individual destination look up table (17) to a related zone controller, in particular the related zone controller controlling the respective junction zone (2i . . . 2s9) related to the look up table.

14. The method according to claim 12, characterized in that a plurality of junction controllers (12) are provided, wherein in each of the junction controller (12i . . . 12s9) an individual destination look up table (17) is stored, in particular the stored destination look up table (17) comprises a list of destinations (D1 . . . D16) linked to one of the outlets (O1, O2, O3) and indicating that an object conveyed (8) through said linked outlet (O) can be conveyed to the linked destination (D).

15. The method according to claim 12, characterized in that the junction controller (12) is adapted to control operation of a related junction zone (2) based on the stored destination look up table (17) related to the junction zone (2i . . . 2s9).
